(19) United States
(12) Patent Application Publication
(10) Pub. No.: US 2026/0141333 A1
(43) Pub. Date: May 21, 2026

(54) NAIL EVALUATING PROGRAM, DEVICE AND METHOD

(71) Applicant: LECHAINON CO., LTD., Yokohama-shi, Kanagawa (JP)

(72) Inventor: Keiji TSUKUDA, Yokohama-shi, Kanagawa (JP)

(73) Assignee: LECHAINON CO., LTD., Yokohama-shi, Kanagawa (JP)

(21) Appl. No.: 19/481,932

(22) PCT Filed: Aug. 6, 2024
(86) PCT No.: PCT/JP2024/028023

§ 371 Date: Nov. 6, 2025

(30) Foreign Application Priority Data
Aug. 17, 2023 (JP) 2023-132927

(51) Int. Cl. G06Q 10/0639; G06T 7/00; G09B 5/06

(52) U.S. Cl. CPC G06Q 10/06398; G06T 7/0002; G09B 5/065

(57) ABSTRACT

Provided are a nail evaluating program, a nail evaluating device, and a nail evaluating method that enable objective evaluations of items included in nail techniques. A computer is caused to carry out: an image acquisition step of acquiring image data of an object of a nail-skill evaluation; an evaluation acquisition step of acquiring evaluation data of a plurality of evaluation items defined with respect to each of a plurality of categories of evaluations performed on the basis of the image data acquired in the image acquisition step; an evaluation step of generating evaluations of the plurality of categories of the evaluations on the basis of evaluations of the plurality of evaluation items that belong to each of the plurality of categories of the evaluations; and an output step of displaying the evaluations of the plurality of categories of the evaluations and the evaluations of the plurality of evaluation items.

### TECHNICAL FIELD

The present invention relates to nail evaluating programs, nail evaluating devices, and nail evaluating methods that perform an evaluation of nails which an evaluated individual has treated, the evaluation being performed on the basis of an image of the nails.

### BACKGROUND

With the growing popularity of nail art, the number of practicing nail technicians is increasing.

Many of the nail technicians enhance their skills on their own by referring, for example, to publicly available information and videos on websites, or by learning from instructors at nail schools.

### SUMMARY

However, there is a problem in that information and teaching methods related to nail techniques widely vary, which makes objective evaluations difficult.

In addition, there is another problem in that, while nail techniques include various items, these items themselves are not clearly defined, which makes it difficult to understand which of these items needs to be improved.

The present invention has been made in view of such circumstances, and an object thereof is to provide a nail evaluating program, a nail evaluating device, and a nail evaluating method that enable objective evaluations of items included in nail techniques.

In addition, another object of the present invention is to provide a nail evaluating program, a nail evaluating device, and a nail evaluating method that enable evaluated individuals to easily further enhance their nail skills on the basis of evaluations they have received.

### SOLUTION TO PROBLEM

The present invention provides a nail evaluating program for causing a computer to carry out:
an image acquisition step of acquiring image data of an object of a nail-skill evaluation;
an evaluation acquisition step of acquiring evaluation data of a plurality of evaluation items defined with respect to each of a plurality of categories of evaluations performed on the basis of the image data acquired in the image acquisition step;
an evaluation step of generating evaluations of the plurality of categories of the evaluations on the basis of evaluations of the plurality of evaluation items that belong to each of the plurality of categories of the evaluations; and
an output step of outputting the evaluations of the plurality of categories of the evaluations and the evaluations of the plurality of evaluation items.

Desirably, the plurality of evaluation items include an evaluation item defined as an essential evaluation item, and
the evaluation step includes performing a first evaluation in which, if the essential evaluation item fails to reach a certain standard, regardless of evaluations of other ones of the plurality of evaluation items, a failing evaluation is assigned as an evaluation of a corresponding one of the plurality of categories of the evaluations, the corresponding one including the essential evaluation item.

Desirably, the plurality of evaluation items include
an intermediate evaluation item and
a plurality of sub-evaluation items at a level lower than a level of the intermediate evaluation item,
the plurality of sub-evaluation items include a sub-evaluation item defined as an essential sub-evaluation item, and
the evaluation step includes performing a first evaluation in which, if the essential sub-evaluation item fails to reach the certain standard, regardless of evaluations of other ones of the plurality of sub-evaluation items, a failing evaluation is assigned as an evaluation of the intermediate evaluation item including the essential evaluation item.

Desirably, the evaluation step includes
performing a second evaluation
   in which an average of the evaluations of the plurality of sub-evaluation items at the level lower than the level of the intermediate evaluation item is calculated as the evaluation of the intermediate evaluation item, the intermediate evaluation item including a plurality of intermediate evaluation items, and
   in which an average of the evaluations of the plurality of intermediate evaluation items at the level lower than a level of the corresponding one of the plurality of categories is calculated as the evaluation of the corresponding one of the plurality of categories, and
assigning a lower one of the first evaluation and the second evaluation as each of the evaluation of the corresponding one of the plurality of categories and the evaluation of the intermediate evaluation item.

Desirably, in the first evaluation, the evaluation of the corresponding one of the plurality of categories and the evaluation of the intermediate evaluation item are evaluated to be equal to or lower than an evaluation of the essential sub-evaluation item at the level lower than the level of the corresponding one of the plurality of categories and the level of the intermediate evaluation item.

Desirably, the output step includes displaying
a sub-evaluation-item display section including a bar graph in which the plurality of sub-evaluation items are sequentially arranged in a vertical direction, and which indicates the respective evaluations of the plurality of sub-evaluation items as bars that extend in a horizontal direction, and
an intermediate-evaluation-item display section including a bar graph in which the plurality of intermediate evaluation items are sequentially arranged in the horizontal direction, and which indicates the respective evaluations of the plurality of intermediate evaluation items as light-colored bars that extend in the vertical direction.

Desirably, the evaluation step includes
using a manual evaluation entered via operation by a human with respect to a human-evaluated item to be evaluated by the human on the basis of the image among the plurality of evaluation items, and
using an image-analysis evaluation generated through an image analysis according to a predetermined criterion on the acquired image with respect to an image-analyzed evaluation item to be automatically evaluated among the plurality of evaluation items.

Desirably, the output step includes displaying a past evaluation in at least one of the sub-evaluation-item display section and the intermediate-evaluation-item display section so that the past evaluation can be compared with a current evaluation.

Desirably, the nail evaluating program further includes
providing, to the evaluated individual, recommended information that recommends one of a learning material and a lesson plan corresponding to the evaluations of the plurality of sub-evaluation items with respect to the evaluated individual on the basis of an associated information obtained by associating the evaluations of the plurality of sub-evaluation items with the one of the learning material and the lesson plan in advance.

A nail evaluating method according to the present invention includes
causing a computer to carry out:
   an image acquisition step of acquiring image data of an object of a nail-skill evaluation;
   an evaluation acquisition step of acquiring evaluation data of a plurality of evaluation items defined with respect to each of a plurality of categories of evaluations performed on the basis of the image data acquired in the image acquisition step;
   an evaluation step of generating evaluations of the plurality of categories of the evaluations on the basis of evaluations of the plurality of evaluation items that belong to each of the plurality of categories of the evaluations; and
   an output step of outputting the evaluations of the plurality of categories of the evaluations and the evaluations of the plurality of evaluation items.

A nail evaluating device according to the present invention includes:
image acquisition means for acquiring image data of an object of a nail-skill evaluation;
evaluation acquisition means for acquiring evaluation data of a plurality of evaluation items defined with respect to each of a plurality of categories of evaluations performed on the basis of the image data acquired by the image acquisition means;
first evaluation means for generating evaluations of the plurality of categories of the evaluations on the basis of evaluations of the plurality of evaluation items that belong to each of the plurality of categories of the evaluations; and
display means for outputting the evaluations of the plurality of categories of the evaluations and the evaluations of the plurality of evaluation items.

According to the present invention, it is possible to provide a nail evaluating program, a nail evaluating device, and a nail evaluating method that enable objective evaluations of items included in nail techniques.

In addition, according to the present invention, it is possible to provide a nail evaluating program, a nail evaluating device, and a nail evaluating method that enable evaluated individuals to easily further enhance their nail skills on the basis of evaluations they have received.

### BRIEF DESCRIPTION OF DRAWINGS

FIG. 1 is an explanatory diagram showing a network environment in which a nail evaluating device 1 according to an embodiment of the present invention is used.

FIG. 2 is a function block diagram of the nail evaluating device 1 shown in FIG. 1.

FIG. 3 is an explanatory table showing evaluation items to be used in the nail evaluation by the nail evaluating device 1.

FIG. 4 is an explanatory flowchart showing processes of the nail evaluating device 1 shown in FIG. 1.

FIG. 5 is an explanatory chart showing a display example of an evaluation display screen 31 showing a result of the nail evaluation.

FIG. 6 is an explanatory flowchart showing another evaluating method to be implemented in the nail evaluating device 1.

FIG. 7 is an explanatory table showing time evaluations by the nail evaluating device 1 according to the embodiment of the present invention.

FIG. 8 is an explanatory chart showing a display example of the time evaluations by the nail evaluating device 1 according to the embodiment of the present invention.

FIG. 9 is an explanatory table showing reference times to be displayed in a screen of the time evaluation shown in FIG. 8.

FIG. 10 is an explanatory chart showing a display example of an overall evaluation by the nail evaluating device 1.

### DETAILED DESCRIPTION OF EMBODIMENTS

Below, a nail evaluating program, a nail evaluating device, and a nail evaluating method according to an embodiment of the present invention are described.

The embodiment described hereinbelow is merely an example of the present invention, and hence the present invention is not limited to this embodiment.

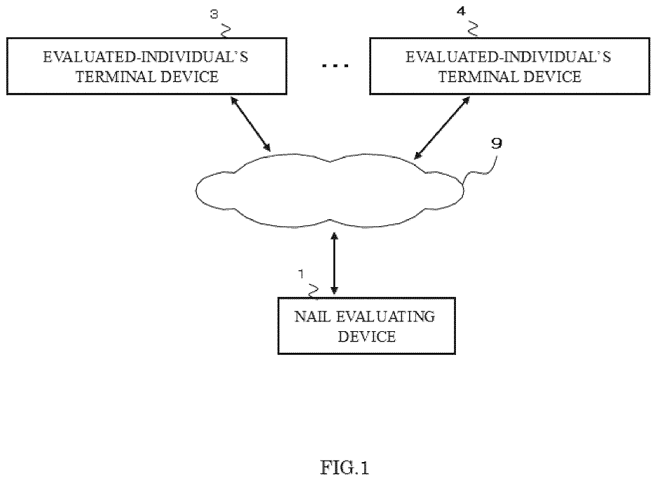

FIG. 1 is an explanatory diagram showing a network environment in which a nail evaluating device 1 according to the embodiment of the present invention is used.

As shown in FIG. 1, the nail evaluating device 1 communicates with an evaluated-individual's terminal device 3 via a network 9.

The evaluated-individual's terminal device 3 is used by an evaluated individual (such as a student). The evaluated individual themselves captures an image of their own nail work by using a camera or the like, and transmits data of this image to the nail evaluating device 1.

The evaluated-individual's terminal device 3 may download a predetermined application, for example, from the nail evaluating device 1, and use functions of the application to perform the image capture and transmission to/reception from the nail evaluating device 1.

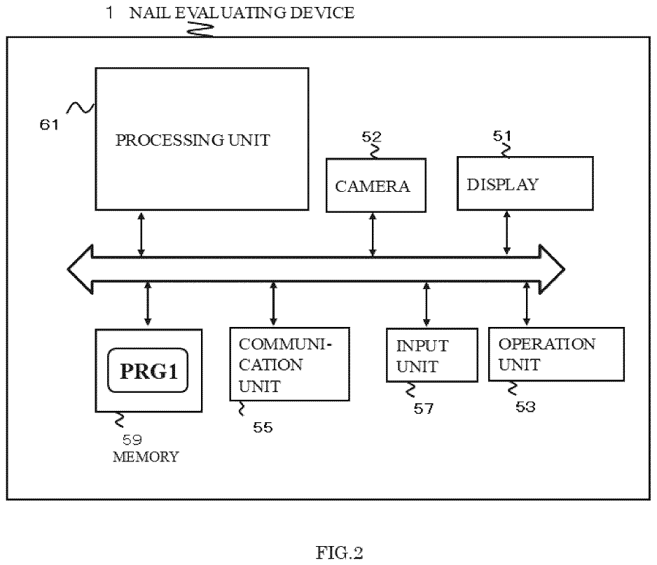

FIG. 2 is a function block diagram of the nail evaluating device 1 shown in FIG. 1.

As shown in FIG. 2, the nail evaluating device 1 includes, for example, a display 51, a camera 52, an operation unit 53, a communication unit 55, a memory 59, and a processing unit 61.

The display 51 displays an image in response to a signal from the processing unit 61.

The camera 52 captures an image of an object.

The operation unit 53 is operation means such as a touchscreen, a keyboard, and a mouse. The communication unit 55 communicates with the evaluated-individual's terminal device 3.

An input unit 57 is, for example, a terminal to which data is entered from outside.

The memory 59 stores a nail evaluating program PRG1 that the processing unit 61 executes.

The processing unit 61 executes the nail evaluating program PRG1 stored in the memory 59 to execute processes of the nail evaluating device 1 according to this embodiment.

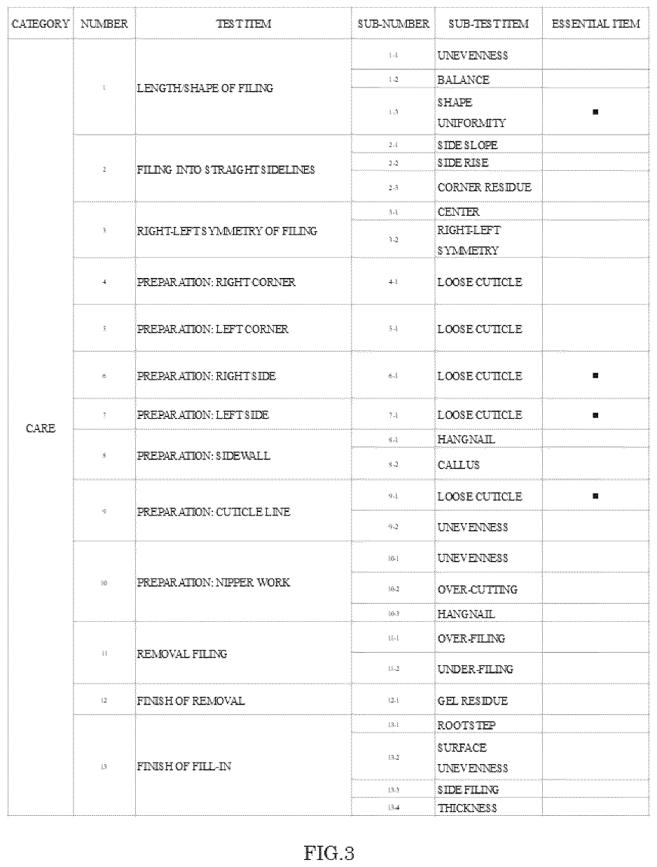

FIG. 3 is an explanatory table showing evaluation items to be used in the nail evaluation by the nail evaluating device 1.

As shown in FIG. 3, the evaluation items that the nail evaluating device 1 uses in the nail evaluation include an evaluation category, intermediate evaluation items, and sub-evaluation items.

The evaluation category is a highest-level evaluation item, and the intermediate evaluation items are at a level lower than that of the evaluation category. In addition, the sub-evaluation items are at a level lower than that of the intermediate evaluation items.

The sub-evaluation items include sub-evaluation items defined as essential sub-evaluation items.

In this embodiment, the evaluation category include those of CARE, ONE COLOR, GRADATION, and TIME, which are merely examples.

In addition, the evaluation category is rated as follows.
AAA . . . Top fundamental skills expected of nail technicians chosen by customers
AA . . . Ideal fundamental skills expected of nail technicians chosen by customers
A . . . Standard fundamental skills expected of nail technicians chosen by customers
B . . . Fundamental skills requiring improvement to those of nail technicians chosen by customers

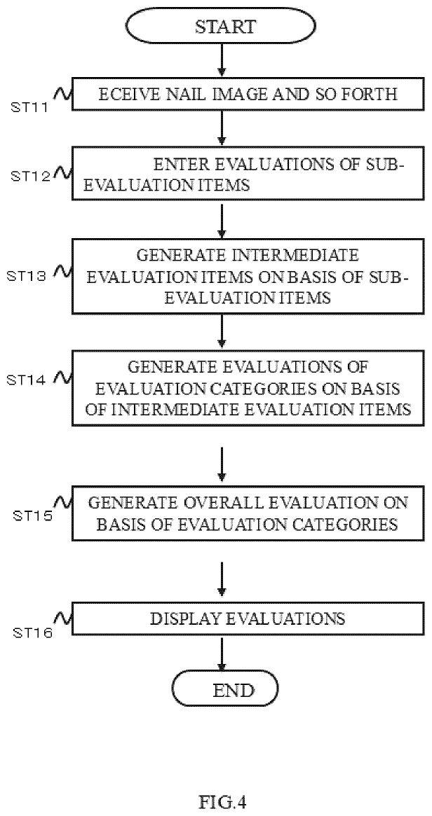

FIG. 4 is an explanatory flowchart showing the processes of the nail evaluating device 1 shown in FIG. 1.

### Step ST11

The communication unit 55 of the nail evaluating device 1 receives image data and text data of nails that an evaluated individual has treated from the evaluated-individual's terminal device 3, associates these data with identification information of the evaluated individual, and stores these data and information in the memory 59.

### Step ST12

The communication unit 55 displays, on the display 51, an image and a text corresponding to the image data and the text data of the nails, the data being acquired in Step ST11.

With reference to the image of and the text about the nails, the image and the text being displayed on the display 51, an evaluator operates the operation unit 53 to enter evaluations of the sub-evaluation items under the categories.

The processing unit 61 associates the entered evaluations of the sub-evaluation items with the identification information of the evaluated individual, and stores the entered evaluations and the identification information in the memory 59.

### Step ST13

The processing unit 61 reads the evaluations (data) of the sub-evaluation items out of the memory 59, then, with respect to each of the intermediate evaluation items, generates evaluations of corresponding ones of the intermediate evaluation items on the basis of the evaluations of the sub-evaluation items that belong to the corresponding ones of the intermediate evaluation items, and stores the evaluations in the memory 59.

### Step ST14

The processing unit 61 reads the evaluations (data) of the intermediate evaluation items out of the memory 59, then, with respect to each of the evaluation categories, generates evaluations of corresponding ones of the evaluation categories on the basis of the evaluations of the intermediate evaluation items that belong to the corresponding ones of the evaluation categories, and stores the evaluations in the memory 59.

### Step ST15

The processing unit 61 reads the evaluations (data) of the intermediate evaluation items out of the memory 59, generates an overall evaluation on the basis of the evaluation categories, and stores the overall evaluation in the memory 59.

### Step ST16

The processing unit 61 reads, out of the memory 59, the evaluations of the sub-evaluation items, the evaluations being stored in the memory 59 in Step ST12, the evaluations of the intermediate evaluation items, the evaluations being generated in Step ST13, the evaluations of the evaluation categories, the evaluations being generated in Step ST14, and the overall evaluation generated in Step ST15, and generates data of an evaluation screen to be displayed on the evaluated-individual's terminal device 3.

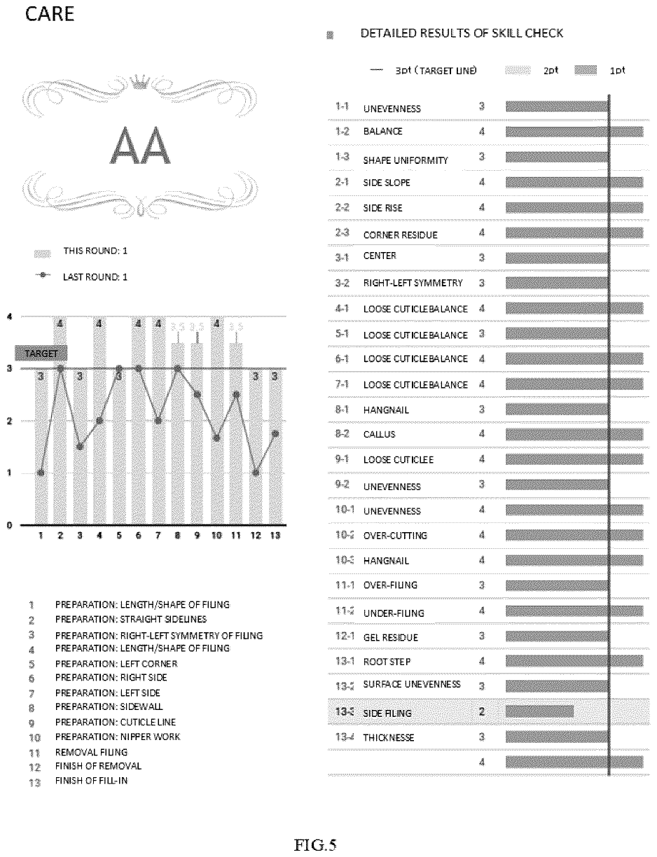

FIG. 5 is an explanatory chart showing a display example of an evaluation display screen 31 showing a result of the nail evaluation.

As shown in FIG. 5, the evaluation display screen 31 includes, for example, a sub-evaluation-item display section 33, an intermediate-evaluation-item display section 35, and an overall-evaluation display section 37.

FIG. 5 shows an example of CARE. The other evaluation categories are shown in a similar manner.

The sub-evaluation-item display section 33 includes a bar graph in which the plurality of sub-evaluation items are sequentially arranged in a vertical direction, and which indicates the respective evaluations of the sub-evaluation items as light-colored bars that extend in a horizontal direction.

The intermediate-evaluation-item display section 35 is located on the left of the sub-evaluation-item display section 33.

The intermediate-evaluation-item display section 35 includes a bar graph in which the plurality of intermediate evaluation items are sequentially arranged in the horizontal direction, and which indicates the respective evaluations of the intermediate evaluation items as bars that extend in the vertical direction.

In addition, the intermediate-evaluation-item display section 35 includes a line graph that indicates a last evaluation.

In the sub-evaluation-item display section 33 and the intermediate-evaluation-item display section 35, a target value of the evaluations (passing score) is indicated, for example, by a red line.

Below, another evaluating method to be implemented in the nail evaluating device 1 is described.

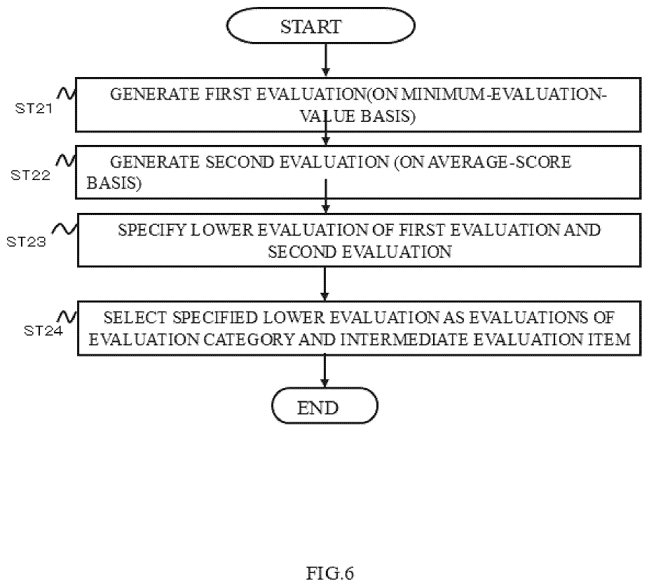

FIG. 6 is an explanatory flowchart showing the other evaluating method to be implemented in the nail evaluating device 1.

### Step ST21

The processing unit 61 of the nail evaluating device 1 performs a first evaluation in which, if any of the essential evaluation items does not reach a certain standard, regardless of the evaluations of the other sub-evaluation items, a failing evaluation (for example, “1 point”) is assigned as each of the evaluation of the intermediate evaluation item and the evaluation of the evaluation category, the item and the category being at the levels higher than that of the essential evaluation item that does not reach the certain standard.

In addition, in the first evaluation, the processing unit 61 evaluates each of the intermediate evaluation items to be equal to or lower than a lowest (minimum) one of evaluations of the essential sub-evaluation items at the level lower than that of the intermediate evaluation item.

### Step ST22

Still further, the processing unit 61 performs a second evaluation in which an average of the evaluations of the plurality of sub-evaluation items at the level lower than that of the intermediate evaluation item is calculated as the evaluation of this intermediate evaluation item, and in which an average of the evaluations of the plurality of intermediate evaluation items at the level lower than that of the evaluation category is calculated as the evaluation of this evaluation category.

### Step ST23

Then, the processing unit 61 specifies a smaller (lower) one of the first evaluation and the heavy-equipment second evaluation.

### Step ST24

The processing unit 61 stores, in the memory 59, the evaluation specified in Step ST23 as the evaluations of the evaluation category and the intermediate evaluation item.

As described above in this embodiment, the image and the text corresponding to the image data and the text data of the nails are displayed on the display 51, and the evaluator views these image and text and enters the evaluations of the sub-evaluation items. Alternatively, the processing unit 61 may perform image analysis of the image of the nails, and automatically generate some or all of the sub-evaluation items.

In other words, with respect to human-evaluated items to be evaluated by a human on the basis of the image among the plurality of sub-evaluation items, manual evaluations entered via the operation by the human are used. Meanwhile, with respect to image-analyzed evaluation items among the plurality of sub-evaluation items, image-analysis evaluations generated by the image analysis according to predetermined criteria on the image acquired by the processing unit 61 are used.

When the sub-evaluation items are associated with lesson materials (such as videos) or lesson plans, the processing unit 61 may provide or recommend the learning materials or the lesson plans to each of the evaluated individuals in accordance with content of the evaluations of the sub-evaluation items.

The provision or the recommendation by the processing unit 61 is performed, for example, as follows.
First: Offer lesson videos corresponding to items of tasks, thereby providing know-how, and opportunities for independent practice.
Second: Propose an online one-on-one lesson with an instructor who excels in solving the tasks (an instructor determined to have a proven track record) or a face-to-face one-on-one lesson with a nearest PNA-certified instructor from the residence of a user, thereby helping the user to directly identify their own habitual weakness that is a root cause of difficulties in the tasks.
Third: Offer a six-month intensive program (available either online or face-to-face), and propose a most suitable instructor and a curriculum for solving the tasks.

The processing unit 61 may execute a process of analyzing how the evaluations have varied after the evaluated individual has incorporated the lesson materials (such as videos) or the lesson plans, and of making an additional proposal.

Further, feedback on a variation in each of the evaluation items of the evaluated individual may be provided to lesson instructors.

Still further, the instructors may be granted incentives such as monetary rewards in accordance with enhancement in skills of the evaluated individual who has taken lessons by the instructors.

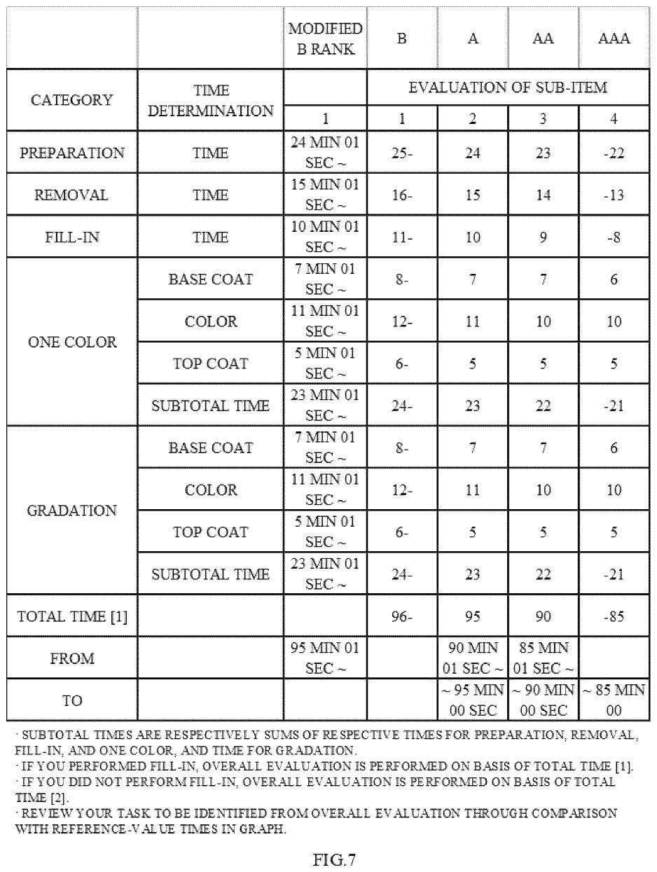

FIG. 7 is an explanatory table showing time evaluations by the nail evaluating device 1 according to the embodiment of the present invention.

As shown in FIG. 7, the nail evaluating device 1 defines PREPARATION, REMOVAL, FILL-IN, ONE COLOR, and GRADATION as the intermediate evaluation items for the time evaluations.

In addition, the intermediate evaluation items each define one or a plurality of sub-evaluation items.

In the example shown in FIG. 7, evaluations of a first round to a fourth round are shown.

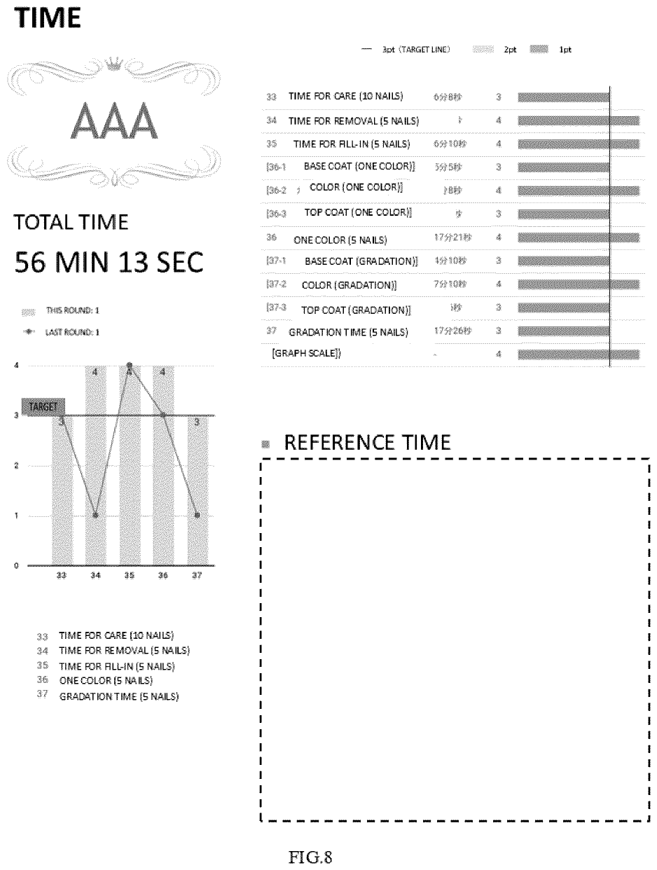

FIG. 8 is an explanatory chart showing a display example of the time evaluations by the nail evaluating device 1 according to the embodiment of the present invention.

As shown in FIG. 8, the nail evaluating device 1 executes a process of displaying the sub-evaluation items, the intermediate evaluation items, and the overall evaluation with regard to the time evaluations.

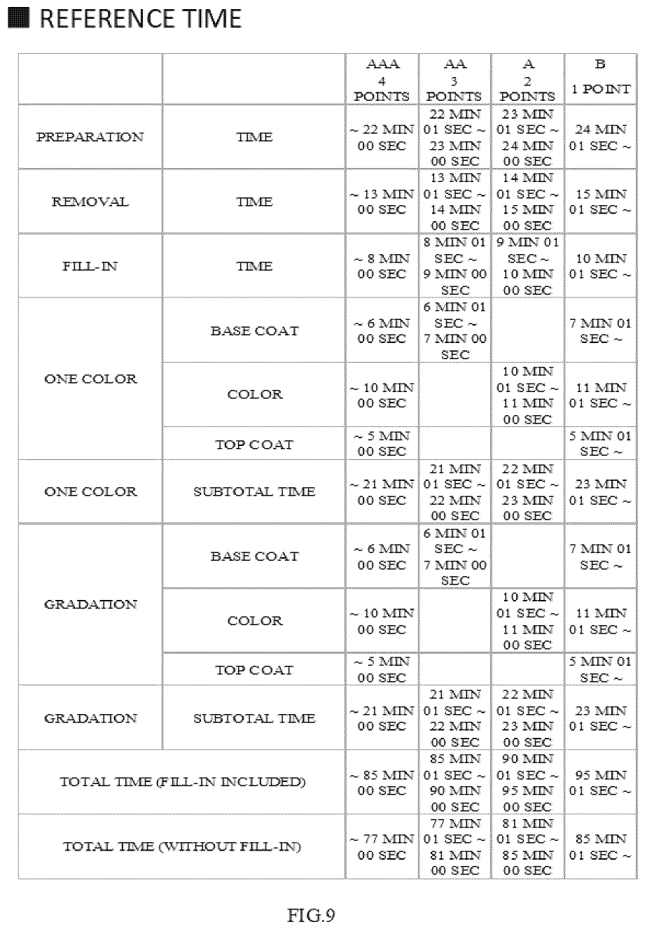

FIG. 9 is an explanatory table showing reference times to be displayed in a screen of the time evaluation shown in FIG. 8.

As shown in FIG. 9, the nail evaluating device 1 displays the intermediate evaluation items and reference evaluations of times for the intermediate evaluation items.

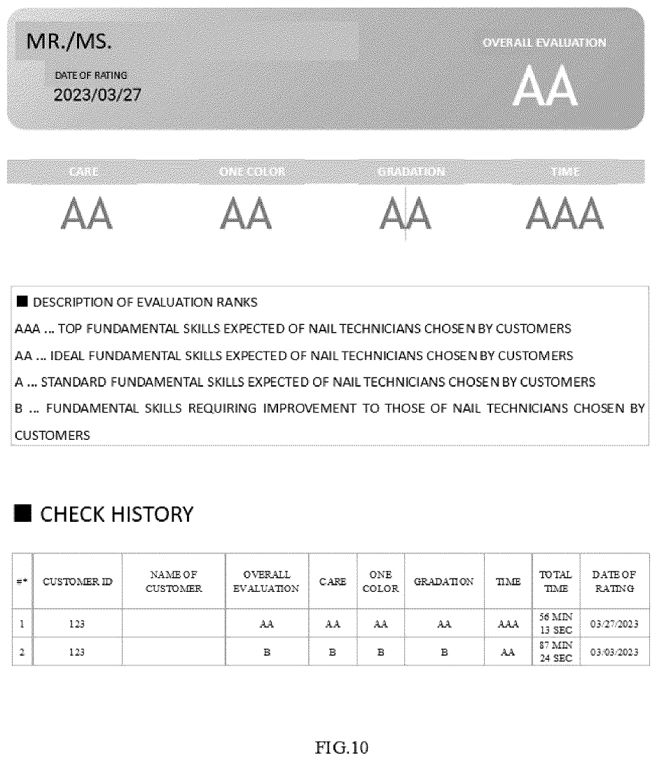

FIG. 10 is an explanatory chart showing a display example of the overall evaluation by the nail evaluating device 1.

As shown in FIG. 10, in Step ST16 shown in FIG. 4 referred to above, the nail evaluating device 1 displays the overall evaluation on the display of the evaluated-individual's terminal device 3.

The evaluated individual can understand their skill level as a nail technician on the basis of the overall evaluation. Further, the evaluated individual can grasp their strength and weakness in each of the evaluation categories.

Still further, the nail evaluating device 1 may analyze evaluations of the evaluation categories, the intermediate evaluation items, and the sub-evaluation items of the plurality of registered evaluated individuals, and specify, for example, tendencies of strength and weakness in each of the items, and progress of improvements according to content of learning materials or educational programs. With this, reference information for improving the learning materials or the educational programs is obtained.

As described above, the nail evaluating device 1 enables objective evaluations of the items included in nail techniques (such as intermediate evaluation items and sub-evaluation items).

Thus, the evaluated individuals can easily further enhance their nail skills on the basis of the evaluations they have received.

Further, the nail evaluating device 1 enables objective certification of the evaluations of the skills of the nail technicians, which can be used as a reference for employment in nail salons. Still further, the nail technicians can promote their own skill levels.

The present invention is not limited to the above-described embodiment.

In other words, those skilled in the art may make various modifications, combinations, and sub-combinations of, and alterations to the components of the embodiment described above within the technical scope of the present invention or the equivalents thereof.

The method of generating (calculating) the evaluation items according to the present invention is not limited to the above-described embodiment.

Further, evaluations need not necessarily be categorized into a hierarchy of the evaluation categories, the intermediate evaluation items, and the sub-evaluation items as in the above-described embodiment.

Still further, methods of displaying the results of the evaluations according to the present invention are not limited to those shown in FIG. 5, FIG. 8, FIG. 9, and FIG. 10.

Yet further, the output step according to the present invention may encompass not only displaying on a screen but also printing.

### INDUSTRIAL APPLICABILITY

The present invention is applicable to nail evaluating systems.

### REFERENCE SIGNS LIST

1 nail evaluating device
3 evaluated-individual's terminal device
PRG1 nail evaluating program.

1-11. (canceled)

12. A computer-implemented nail evaluating program comprising steps of:
an image acquisition step of acquiring image data of an object of a nail-skill evaluation;
an evaluation acquisition step of acquiring evaluation data of a plurality of evaluation items defined with respect to each of a plurality of categories of evaluations performed on a basis of the image data acquired in the image acquisition step;
an evaluation step of generating evaluations of the plurality of categories of the evaluations on a basis of evaluations of the plurality of evaluation items that belong to each of the plurality of categories of the evaluations; and
an output step of outputting the evaluations of the plurality of categories of the evaluations and the evaluations of the plurality of evaluation items.

13. The computer-implemented nail evaluating program according to claim 12, wherein
the plurality of evaluation items include an evaluation item defined as an essential evaluation item, and
the evaluation step includes performing a first evaluation in which, if the essential evaluation item fails to reach a certain standard, regardless of evaluations of other ones of the plurality of evaluation items, a failing evaluation is assigned as an evaluation of a corresponding one of the plurality of categories of the evaluations, the corresponding one including the essential evaluation item.

14. The computer-implemented nail evaluating program according to claim 13, wherein
the plurality of evaluation items include:
an intermediate evaluation item and
a plurality of sub-evaluation items at a level lower than a level of the intermediate evaluation item,
the plurality of sub-evaluation items include a sub-evaluation item defined as an essential sub-evaluation item, and
the evaluation step includes performing a first evaluation in which, if the essential sub-evaluation item fails to reach the certain standard, regardless of evaluations of other ones of the plurality of sub-evaluation items, a failing evaluation is assigned as an evaluation of the intermediate evaluation item including the essential evaluation item.

15. The computer-implemented a nail evaluating program according to claim 14, wherein
the evaluation step includes:
performing a second evaluation
in which an average of the evaluations of the plurality of sub-evaluation items at the level lower than the level of the intermediate evaluation item is calculated as the evaluation of the intermediate evaluation item, the intermediate evaluation item including a plurality of intermediate evaluation items, and
in which an average of the evaluations of the plurality of intermediate evaluation items at the level lower than a level of the corresponding one of the plurality of categories of the evaluations is calculated as the evaluation of the corresponding one of the plurality of categories of the evaluations, and
assigning a lower one of the first evaluation and the second evaluation as each of the evaluation of the corresponding one of the plurality of categories of the evaluations and the evaluation of the intermediate evaluation item.

16. The computer-implemented nail evaluating program according to claim 15, wherein,
in the first evaluation, the evaluation of the corresponding one of the plurality of categories of the evaluations and the evaluation of the intermediate evaluation item are evaluated to be equal to or lower than an evaluation of the essential sub-evaluation item at the level lower than the level of the corresponding one of the plurality of categories of the evaluations and the level of the intermediate evaluation item.

17. The computer-implemented nail evaluating program according to claim 16, wherein
the output step includes displaying
a sub-evaluation-item display section including a bar graph in which the plurality of sub-evaluation items are sequentially arranged in a vertical direction, and which indicates the respective evaluations of the plurality of sub-evaluation items as bars that extend in a horizontal direction, and
an intermediate-evaluation-item display section including a bar graph in which the plurality of intermediate evaluation items are sequentially arranged in the horizontal direction, and which indicates the respective evaluations of the plurality of intermediate evaluation items as bars that extend in the vertical direction.

18. The computer-implemented nail evaluating program according to claim 17, wherein
the evaluation step includes:
using a manual evaluation entered via operation by a human with respect to a human-evaluated item to be evaluated by the human on a basis of an image among the plurality of evaluation items, and
using an image-analysis evaluation generated through an image analysis according to a predetermined criterion on the acquired image with respect to an image-analyzed evaluation item to be automatically evaluated among the plurality of evaluation items.

19. The computer-implemented nail evaluating program according to claim 17, wherein
the output step includes displaying a past evaluation in at least one of the sub-evaluation-item display section and the intermediate-evaluation-item display section so that the past evaluation can be compared with a current evaluation.

20. The computer-implemented nail evaluating program according to claim 17, further comprising:
providing, to an evaluated individual, recommended information that recommends one of a learning material and a lesson plan corresponding to the evaluations of the plurality of sub-evaluation items with respect to the evaluated individual on a basis of an associated information obtained by associating the evaluations of the plurality of sub-evaluation items with the one of the learning material and the lesson plan in advance.

21. A nail evaluating method, comprising
causing a computer to carry out:
an image acquisition step of acquiring image data of an object of a nail-skill evaluation;
an evaluation acquisition step of acquiring evaluation data of a plurality of evaluation items defined with respect to each of a plurality of categories of evaluations performed on a basis of the image data acquired in the image acquisition step;
an evaluation step of generating evaluations of the plurality of categories of the evaluations on a basis of evaluations of the plurality of evaluation items that belong to each of the plurality of categories of the evaluations; and
an output step of outputting the evaluations of the plurality of categories of the evaluations and the evaluations of the plurality of evaluation items.

22. A nail evaluating device, comprising:
image acquisition means for acquiring image data of an object of a nail-skill evaluation;
evaluation acquisition means for acquiring evaluation data of a plurality of evaluation items defined with respect to each of a plurality of categories of evaluations performed on a basis of the image data acquired by the image acquisition means;
first evaluation means for generating evaluations of the plurality of categories of the evaluations on a basis of evaluations of the plurality of evaluation items that belong to each of the plurality of categories of the evaluations; and
output means for outputting the evaluations of the plurality of categories of the evaluations and the evaluations of the plurality of evaluation items.
